(19) United States
(12) Patent Application Publication
(10) Pub. No.: US 2025/0312713 A1
(43) Pub. Date: Oct. 9, 2025

(54) RING FILTER CARTRIDGE FOR FILTRATION OF OIL SANDS SLURRIES AND RELATED METHODS

(71) Applicant: SYNCRUDE CANADA LTD. IN TRUST FOR THE OWNERS OF THE SYNCRUDE PROJECT AS SUCH C, Edmonton (CA)

(72) Inventor: Andrew SELL, Edmonton (CA)

(73) Assignee: SYNCRUDE CANADA LTD. IN TRUST FOR THE OWNERS OF THE SYNCRUDE PROJECT AS SUCH C, Edmonton (CA)

(21) Appl. No.: 18/625,214

(22) Filed: Apr. 3, 2024

(51) Int. Cl. B01D 29/74; B01D 29/15

(52) U.S. Cl. CPC B01D 29/74; B01D 29/15; B01D 2201/0415

(57) ABSTRACT

The present relates to an oil sands slurry filter cartridge that includes first and second sets of filter rings that are alternately arranged to form a stack with an interior passage, and where the filter rings are spaced apart to define a filtration gap in between adjacent pairs of filter rings. The filter cartridge can be configured such that the first and second sets of filter rings are rotatable with respect to each other to facilitate self-cleaning. The filter cartridge can be configured such that each filter ring has a wedge shaped profile tapering inwardly toward the passage for enhanced filtration functionality.

### TECHNICAL FIELD

The technical field generally relates to filter units used in processing oil sands slurries to remove particulate solids.

### BACKGROUND

In oil sands processing, filter units can be used to remove oversize solids and low density particles to prevent plugging of downstream equipment. For example, an auto-cleaning disk stack filter unit can be used in some unit operations, but such units can have drawbacks including premature wear leading to frequent replacement of filter cartridges. There is a need for a technology that overcomes at least some of the drawbacks of known techniques.

### SUMMARY

The technology includes a filter cartridge and related methods for filtering solid particles from an oil sands slurry. The filter cartridge can include configurations such that two filter components rotate with respect to each other and/or where filter rings have wedged-shaped profiles tapering inward toward the downstream flow direction.

In some implementations, there is provided an oil sands slurry filter cartridge for filtering solid particles from an oil sands slurry, comprising: a first filter component comprising: a first set of filter rings; and a first support structure supporting the first set of filter rings. There is also a second filter component comprising: a second set of filter rings arranged in alternating relation with respect to the first set of filter rings; and a second support structure supporting the second set of filter rings. The first and second sets of filter rings form a stack having a passage defined within the stack and having an outlet, and wherein a filtration gap is defined between each adjacent pair of filter rings to filter the solid particles while allowing fluid to pass therethrough into the passage and then expelled via the outlet. There is also a bearing system configured to provide spacing between the first and second sets of filter rings, and a drive system configured to provide rotation of the first and second sets of filter rings with respect to each other.

In some implementations, the first support structure is provided on an inner side of the first set of filter rings, and the second support structure is provided on an outer side of the second set of filter rings. In some implementations, the first support structure comprises a plurality of spaced-apart vertical support columns and first annular supports at opposed ends of the vertical support columns, each of the vertical support columns being connected to the filter rings of the first set of filter rings. In some implementations, the second support structure comprises a plurality of spaced-apart spiral support members and second annular supports at opposed ends of the spiral support columns, each of the spiral support columns being connected to the filter rings of the second set of filter rings. In some implementations, the drive system comprises a motor coupled to a drive shaft, wherein the drive shaft is coupled to the first support structure for rotating the first support structure and the first set of filter rings. In some implementations, the drive system configured to provide rotation of the first set of filter rings while the second set of filter rings are configured to remain stationary. In some implementations, the first and second sets of filter rings are sized and configured to receive solids-containing diluted bitumen as the oil sands slurry. In some implementations, the filtration gap is between 100 and 400 microns. In some implementations, the filter rings of the first and second sets of filter rings each have a wedge-shaped profile tapering inward toward the passage. In some implementations, the first and second filter components are configured such that the stack and the passage are oriented vertically with the outlet at a bottom end, when installed in a filtration vessel.

In some implementations, there is provided an oil sands slurry filter cartridge for filtering solid particles from an oil sands slurry, comprising: a first filter component comprising: a first set of filter rings; and a first support structure supporting the first set of filter rings. There is also a second filter component comprising: a second set of filter rings arranged in alternating relation with respect to the first set of filter rings; and a second support structure supporting the second set of filter rings. The first and second sets of filter rings form a stack having a passage defined within the stack and having an outlet, and wherein a filtration gap is defined between each adjacent pair of filter rings to filter the solid particles while allowing fluid to pass therethrough into the passage and then expelled via the outlet; and the filter rings of the first and second sets of filter rings have respective wedged-shaped profiles tapering inward toward the passage.

In some implementations, the first support structure is provided on an inner side of the first set of filter rings, and the second support structure is provided on an outer side of the second set of filter rings. In some implementations, the wedged-shaped profile of each filter ring of the first set of filter rings comprises: a neck extending outwardly from the first support structure; and a wedge-shaped head extending and tapering outwardly from the neck and having an end surface that is spaced apart from the second support structure. In some implementations, the wedged-shaped profile of each filter ring of the second set of filter rings comprises: a base extending inwardly from the second support structure; and a wedge-shaped head extending and tapering inwardly from the base and having an end tip that is spaced apart from the first support structure. In some implementations, the end surface is located along a same plane as an inner end of the base. In some implementations, the end surface has a width that is the same as that of the base. In some implementations, the wedge-shaped profile is the same for each filter ring. In some implementations, the first and second sets of filter rings are configured to be rotatable with respect to each other. In some implementations, the first and second sets of filter rings are sized and configured to receive solids-containing diluted bitumen as the oil sands slurry. In some implementations, the first and second filter components are configured such that the stack and the passage are oriented vertically with the outlet at a bottom end, when installed in a filtration vessel. In some implementations, the first and second sets of filter rings are configured such that the passage defines a tortuous path.

In some implementations, there is provided a method for filtering an oil sands slurry comprising passing a flow of the oil sands slurry to a filtration unit comprising at least one filter cartridge as defined above or herein to remove the solid particles therefrom and produce a solids-depleted fluid, and withdrawing the solids-depleted fluid from the filtration unit.

### BRIEF DESCRIPTION OF THE DRAWINGS

FIG. 1 is a perspective partial cut view schematic of an example filter cartridge.

FIG. 2 is a close-up, side view schematic of example filter rings that can be part of a filter cartridge.

FIG. 3 is a side view schematic of an example filter cartridge.

FIG. 4 is a side cross-sectional view schematic of an example filter cartridge.

FIG. 5 is a side cross-sectional view schematic of a close-up region of FIG. 4.

FIG. 6 is a side cross-sectional view schematic of part of an example filter cartridge.

FIGS. 7A and 7B are bottom perspective view schematics of part of an example filter cartridge.

FIG. 8 is a close-up, perspective view schematic of part of an example filter cartridge.

FIG. 9 is a side view schematic of example filter rings that can be part of a filter cartridge.

FIG. 10 is a perspective cut view schematic of an example vessel in which filter cartridges can be used.

FIG. 11 is a side cut view schematic of example rings that are configured and shaped to provide a tortuous path for filtration.

FIG. 12A is a perspective view of an example bearing assembly and FIG. 12B is a perspective cut view thereof.

FIG. 13 is a cut view of an example bearing implement.

### DETAILED DESCRIPTION

The present description relates to a filter cartridge for use in a filtration unit used to remove solid particles from oil sands slurries. The filter cartridge can have various features, such as stacked filter rings with a wedge-shaped profile tapered inwardly toward a central fluid passage where the filtered fluid flows as well as two sets of filter rings that rotate with respect to each other to facilitate self-cleaning functionality.

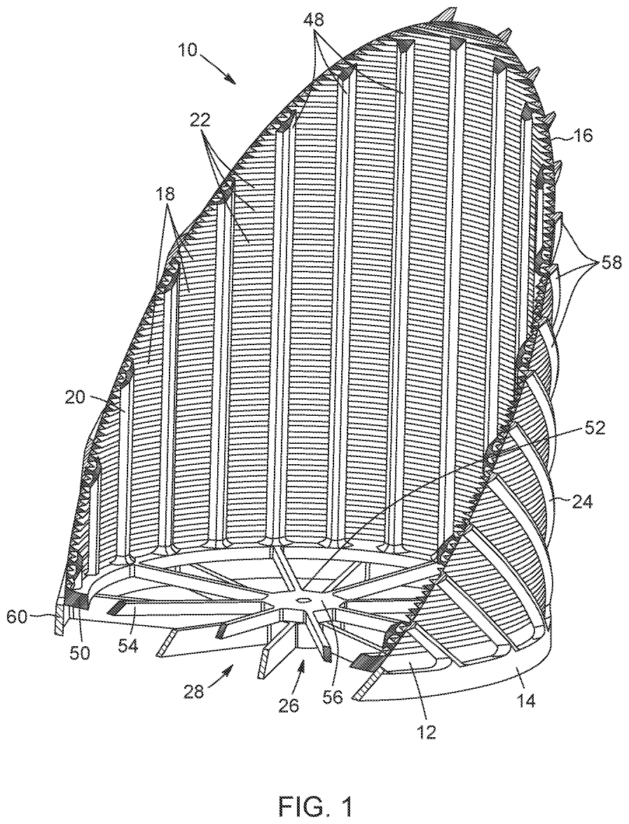

Referring to FIG. 1, the filter cartridge 10 can include a first filtration component 12 and a second filtration component 14 that include alternative rings that form a stack 16. The first filtration component 12 includes a first set of rings 18 and a first support structure 20, and the second filtration component 14 includes a second set of rings 22 and a second support structure 24. The stack 16 also has a passage 26 defined within the rings and the passage has an outlet 28. The oil sand slurry flows through gaps defined between adjacent rings into the passage 26 and then the resulting filtered fluid is expelled through the outlet 28. In the implementations shown in FIG. 1, the fluid flows laterally into the passage 26 and then down toward the outlet 28.

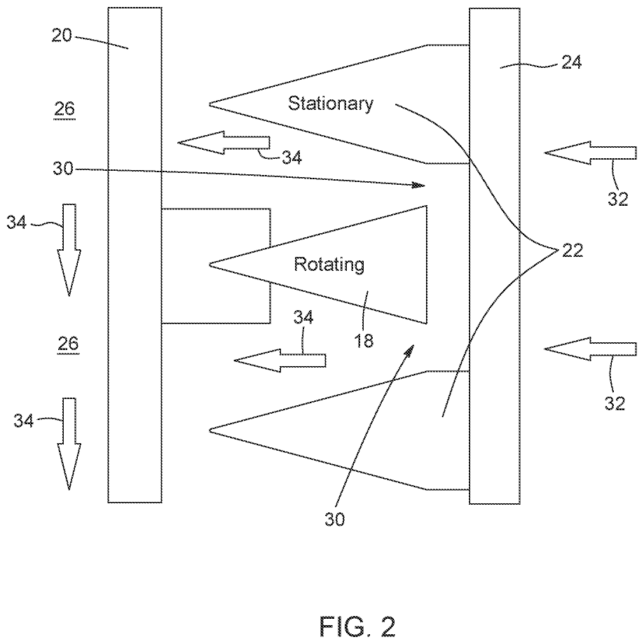

Referring now to FIG. 2, the first set of filter rings 18 and the second set of filter rings 22 provided in alternating relation define, between each adjacent pair of rings, a filtration gap 30. The filtration gap 30 is sized to prevent a certain size of particle solid to pass into the passage. The gap can be sized to prevent particles greater than 380 microns, for example, from passing through, although other gap sizes are possible depending on the process design and nature of the slurry. The oil sand slurry 32 can flow toward the gaps and the solids-depleted fluid 34 flows into the passage 26 and toward the outlet.

In some implementations, the first and second filter components 12, 14 can be configured to rotate with respect to each other to facilitate self-cleaning of the filter cartridge. For example, one of the components can be stationary while the other coupled to a motor and is rotated about its longitudinal axis. In some implementations, the inner filter component, shown as the first filter component in FIGS. 1 and 2, is the rotating component while the outer filter component, shown as the second filter component in FIGS. 1 and 2, is stationary. However, it is noted that the outer filter component can be the one that rotates while the inner one remains stationary, or both filter components can rotate (e.g., in opposite directions or alternating). The filter components can be configured, along with the motor and drive systems, to be rotatable in one direction or both directions. In operation, when the first filter component rotates, the first set of filter rings rotate with respect to the second set of filter rings. In the illustrated implementation, every other ring is rotating and thus the tolerance between rotating and non-rotating elements becomes the same as the filtration specification, such that it is easier to maintain no contact between the rings, especially for small filtration specifications. This self-cleaning rotating design provides advantages over known designs of mechanically cleaned filter elements that use cleaning blades or ploughs-and-scrapper designs that have very small gaps or contact points between moving elements.

In some implementations, the filter rings of the first and second sets of filter rings have respective outer profiles that are wedged-shaped tapering inward toward the passage, as shown in FIG. 2 for example. The wedge shapes enable various functionalities, such as facilitating larger gaps between rotating and non-rotating parts (e.g., 380 microns vs. 40 microns), and reducing the chance of wedging or pinching debris between the rings.

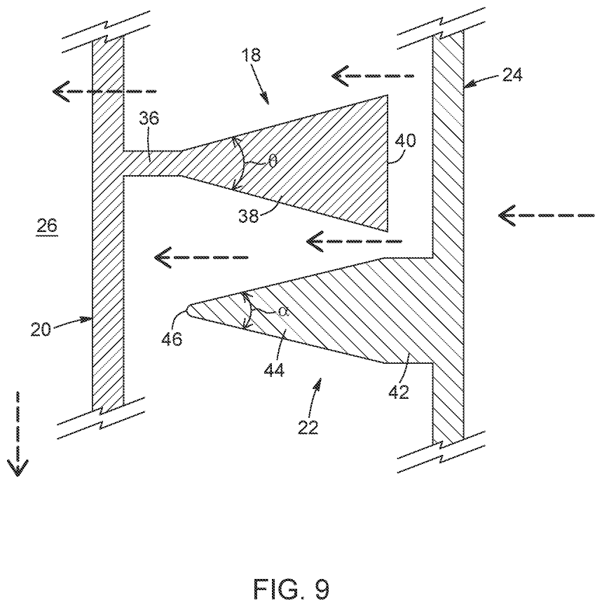

Turning now to FIG. 9, the inner filter rings (here, the first set of filter rings 18) can each include a neck 36 extending outward from the first support structure 20, and a wedge-shaped head 38 extending and tapering out from the neck 36. The wedge-shaped head 38 can also have an end surface 40 that is spaced apart from the second support structure 24. In addition, the outer filter rings (here, the second set of filter rings 22) can each include a base 42 extending inwardly from the second support surface 24, and a second wedge-shaped head 44 extending and tapering inwardly from the base 42 and having an end tip 46 that is spaced apart from the first support structure 20. In some implementations, the end tip 46 can vertically align with where the neck 36 meets the first head 38, and the end surface 40 can align with where the base 42 meets the second head 44. In addition, the geometry can be provided such that the closest gap between the first head 38 and the base 42 is generally the same as the space between the end surface 40 and the second support structure 24 as well as the space between the end tip 46 and the first support structure 20. It is also noted that other arrangements and spacings are possible.

It is also noted that the wedge-shaped profiles can be provide with additional surface features, such as rounded corners (e.g., at the end tip 46 and at the two opposed corners of the first head 38). The wedge-shaped profiles can have certain angles, e.g., a and e as shown in FIG. 9, which can be between 35° and 80°, for example, and it is noted that fabrication techniques can have an impact as well. For example, certain fabrication methods can limit the overdraft angle that can be produced. In most cases, the angle will be within 35-80°, 40-70° or 45-65°. In addition, in terms of dimensions and sizing, the filter rings can be sized depending on the particle size to be filter and the nature of the slurry. In one example, the filter rings can have ring profile variations over the length of the cartridge to account of density differences in the types of debris. The rings 18, 22 could change to a more circular profile with the end surface 40 having a large curvature (100× or more the filtration specification). Additional tortuosity could be implemented by increasing the length of the inner support sections 36 and 42 and incorporating one or more rounded ridges on the top and/or bottom of either the 18 or 22 ring profiles to cause the flow to switch directions such that overlapping sections of the rings help increase capture rate of low density stringy material that may concentrate near the top of the cartridge. See FIG. 11 which illustrates such an embodiment with increased tortuosity.

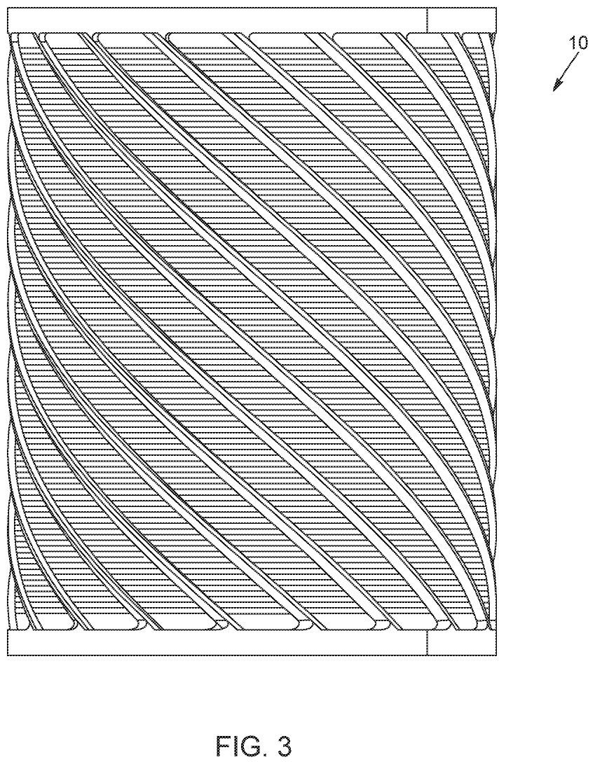

Referring to FIG. 1 and specifically turning toward the support structures that hold the filter rings in place, the first and second support structures 20, 24 can include a plurality of elongated posts or columns which can have various orientations, configurations, and sizing. For example, the elongated structures can be vertical, diagonal, or spiral. The elongated structures can be spaced apart from each other and can be generally parallel with respect to each other, as illustrated in FIG. 1, or there could be some crossover of the elongated structures to form certain patterns (e.g., “X” patterns). The elongated structures can each extend the height of the cartridge and can be connected at either end to respective annular supports. More specifically, the first support structure 12 can include a plurality of first support columns 48 that are vertical and evenly spaced apart about the passage; and are connected to a lower annular support 50 and an upper support (not shown in FIG. 1). The lower annular support 50 can also be part of a wheel 52 having spokes 54 and a hub 56 to which the drive shaft of the motor (not shown) can attach when the first filter component (12) is the rotating component. The second support structure 14 can include a plurality of second support members 58 that are each oriented in a spiral pattern and are evenly spaced apart from each other; and are connected to a base annular support 60 and a top support (not shown in FIG. 1; but see FIG. 3). The base annular support 60 can also have a wheel-like configuration and can be configured to fit within a cartridge receptacle in the filtration unit. Regarding the supports at the top of the cartridge, in some implementations, the top of the cartridge is closed so that fluid communication with the passage is prevented, such that flow of the fluid enters in the radial direction from outside the cartridge, into the passage, and down until exiting via the outlet.

Referring to FIG. 3, the helical or spiral support members can be seen sweeping across the surface of the cartridge. Every other ring is attached to these helical support rods. The helical shape can help convey filtered debris off/down the cartridge with the rotating of the inner first set of filter rings. The number of helical support rods and pitch of the helix can vary based on the slurry being filtered and stiffness required. The helical shape is not required and could be replaced by straight vertical rods, for example. The number of rods increases the stiffness of the filter cartridge assembly, though at the expense of open filtration area. The material used to form the rods can also influence their thickness and stiffness and can be selected accordingly.

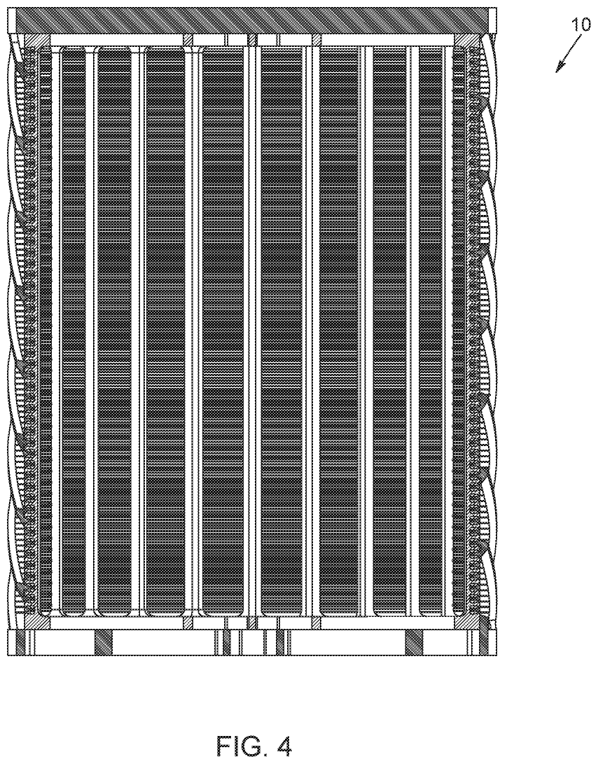

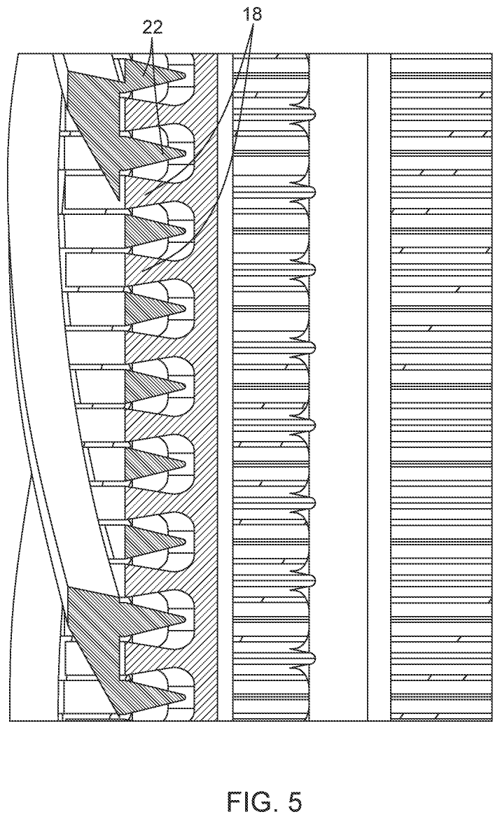

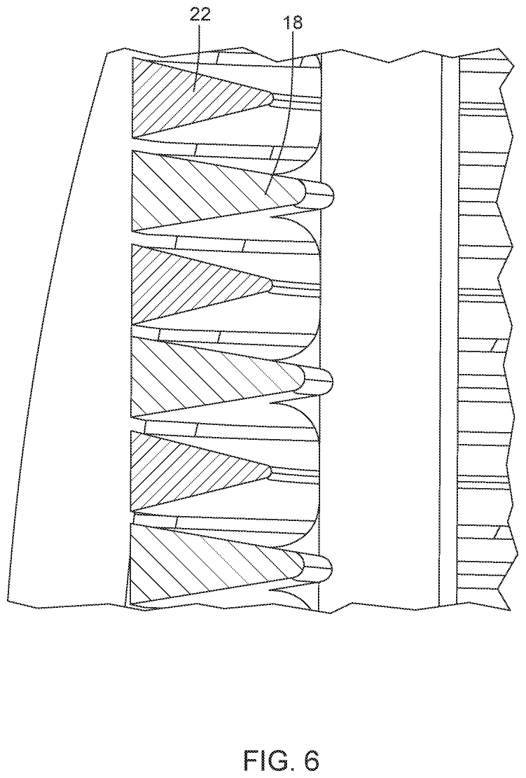

Referring to FIGS. 4 to 6, the filter rings are preferably concentric and the wedge profile shape is general the same for each ring, except where the rings attach to the first or second support structure. Since every other ring is attached to the rotating internal support structure, every other ring would be rotating with it. FIG. 6 is similar to FIG. 5, but without the section going through the inner support to show the stacked concentric filter rings. It is noted that the filtration gap size increases in the direction of flow (external to internal, and left to right for FIG. 6) to help limit the number of pinch points.

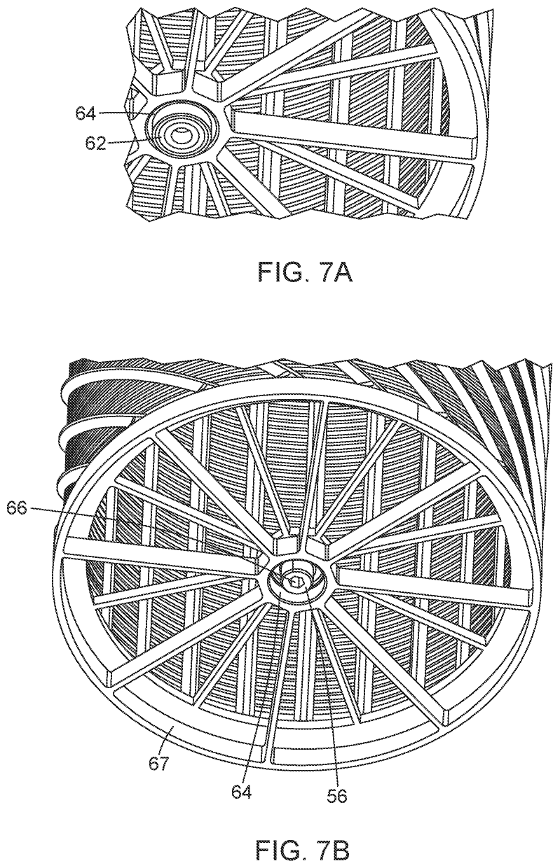

Referring to FIGS. 7A and 7B, the filter cartridge also includes a bearing system in between the first and second filter components. The bearing system can include upper and lower bearings. FIG. 7A shows a lower bearing 62 that can be located in a bearing annulus 64 separating the rotating and stationary components. The bearing annulus 64 is present to hold the bearing which keeps the rotating and non-rotating structures separated. A similar configuration with an upper bearing annulus and an upper bearing can also be present at the top of the cartridge. In addition, the hub 56 can include a hex hole 66 is where the drive shaft of the motor would mate with the rotating internal structure to drive the rotating ring stack, while the external support structure would be fastened (e.g., bolted) to a stationary base within the vessel. The bearing could alternatively be provided in other locations, such as on the outer most diameter or on an annular surface 67. The bearing can be a rolling element bearing or a plain bearing, for example. FIG. 7A is a close-up view of part of FIG. 7B with the lower bearing 62 shown.

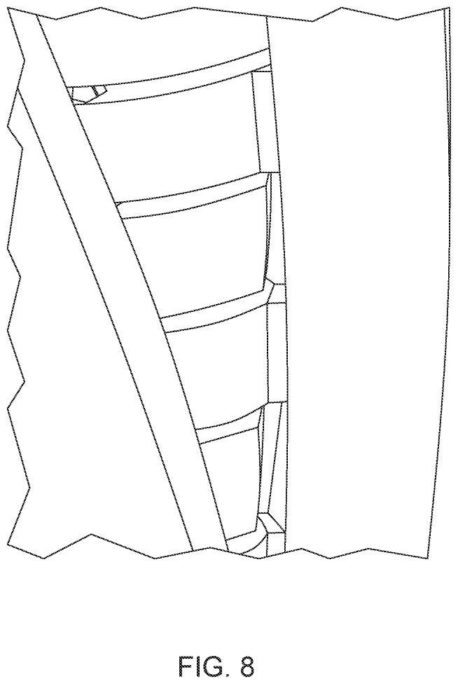

Referring to FIG. 8, a close-up of the stationary ring attachment is shown where the second set of rings are connected to the second support structure. This figure shows an example and various other shapes and configurations are possible for such attachment points.

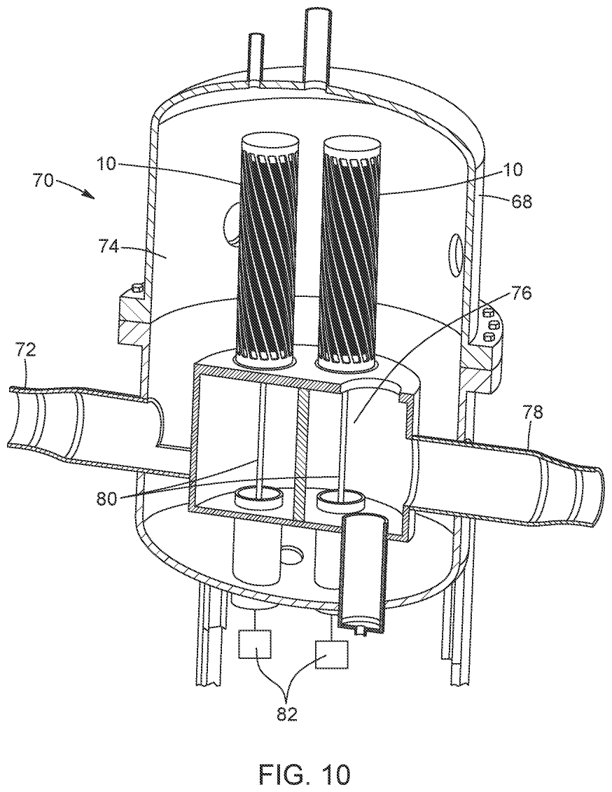

In operation, referring to FIG. 10, one or more filter cartridge 10 can be mounted within a vessel 68 that is part of a filtration unit 70 that receives oil sands slurry for filtration. The cartridges can facilitate continuous self-cleaning and non-contact between wedge filter rings for enhanced operations. The slurry is fed via a filter inlet 72 and enters an upper chamber 74 of the vessel 68 where it passes through the filtration gaps in the cartridges 10 that are mounted in the vessel 68. The filtered slurry passes down into a lower chamber 76 and then is expelled via a filter outlet 78. The filter cartridges 10 can be replaced when required. A drive shaft 80 and motor 82 can be provided for each filter cartridge 10, and the filtration unit can be equipped with tubulars and associated equipment that enable coupling to motor-driven cartridges 10.

It is also noted that the filter ring profiles are provided to open into the filtration direction like a triangular profile to reduce the chance of pinching/plugging,

In terms of manufacturing, the filter cartridge can be made using three-dimensional printing methods using materials selected based on the slurries to be filtered and the operating parameters. In the illustrated implementations, the internal component (including the first support structure and the first set of filter rings) and the external component (including the second support structure and the second set of filter rings) are each made as one whole and integral part. The filter cartridge can thus be made having two distinct structures, which are 3D printed together as an “assembly” to be entwined as illustrated, while being two distinct components that are not actually connected. The internal structure can rotate, while the external structure is stationary. One or more bearings are used to maintain the gap and tolerance between the rotating and non-rotating structures. It is also noted that the gap between the filter rings can be maintained axially and radially through use of the bearings on either end of the cartridge and to also prevent contact between the rotating parts by maintaining the filtration gap.

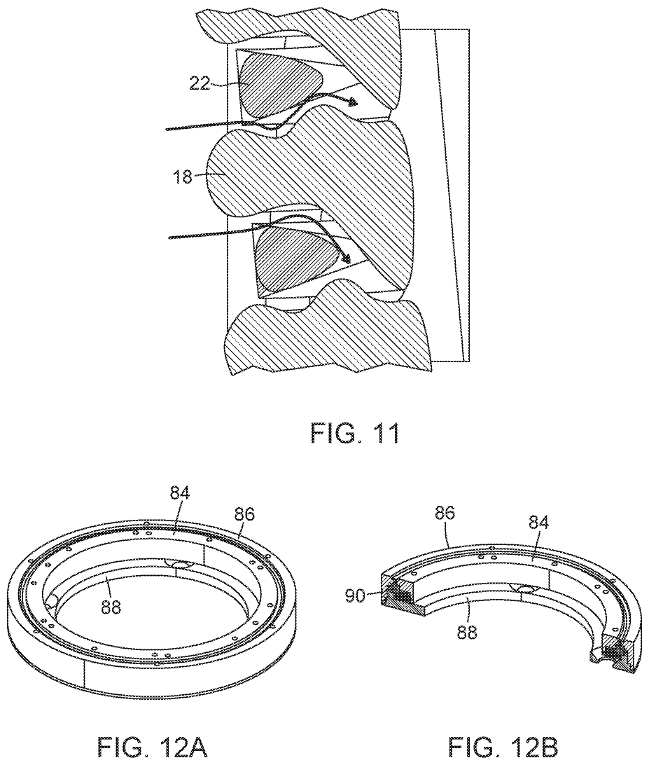

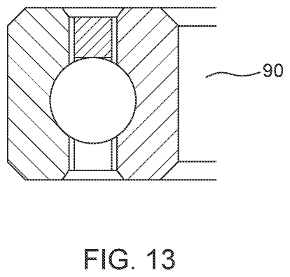

It is noted that there are several ways the overall assembly could be provided and assembled with a bearing system. In one example, one can insert a bearing in the annulus as shown in FIG. 7A. The bearing can be fixed or held axially to maintain the filtration specification (e.g., with a bearing thrust cap). In another example, a bearing assembly could be provided to attach to the first and second filtration components 12, 14. An example of a lower bearing assembly is shown in FIGS. 12A and 12B. In this example, the lower bearing includes an inner rotating structure 84 mountable (e.g., via bolting through illustrated holes) to the first filtration component, an outer stationary structure 86 mountable (e.g., via bolting through illustrated holes) to the second filtration component, a mounting plate 88, and a bearing implement 90. The bearing implement 90 can have a structure shown in FIG. 13. The top bearing of the filter cartridge could be configured as a similar assembly, but could be provided with a closed cap instead of an open mounting plate. Such a bearing assembly can facilitate dividing the fabrication of the filter cartridge and use 3D-printing only when advantageous or necessary, and then fabricate all bearing housing pieces using traditional methods.

With additive and 3D printing technologies, such as laser powder bed fusion, binder jetting, fused deposition modeling, directed energy deposition, and/or 3D sand moulding, the filter cartridges could be composed of many different types of metal alloy, ceramic, and/or polymer materials. The materials and process of manufacture can be provided to suite the target fluid conditions being filtered, the size of the desired cartridge, the desired filtration specification (e.g., spacing between the rings), and the like.

It is also noted that the filter cartridge can be provided as a single printed two-piece assembly, or it can be assembled by making multiple cartridge sections that are connected end-to-end. In the latter case, the lowest cartridge section would have an open bottom acting as the outlet, and would have an open top to provide fluid communication with the next cartridge section, and the top cartridge section would have the closed top. Thus, the height of the assembled cartridge can be adjusted by using interlocking ring designs so that the cartridge can be produced in several “stacked” sections that are printed separately and then assembled end-to-end, or all in one piece, depending on the fabrication process employed.

The filter cartridge and associated methods described herein can facilitate advantages, such as reduced maintenance cost (e.g., reduced flushing frequency notably), increase reliability with associated reduction in negative impact on downstream equipment (e.g., filtration impacts centrifuges and downstream equipment in extraction), debottlenecking (e.g., adding more bitumen production per year by lowering the flush frequency), and enabling filtration specification smaller than 380 microns, if desired. Whereas known self-cleaning filters can lead to metal-on-metal (e.g., between rotating disc stack and stationary cleaning blades) due to small tolerances, resulting in high wear rates and frequent change-outs, the filter cartridge designs provided herein have reduced wear and enhanced performance.

1. An oil sands slurry filter cartridge for filtering solid particles from an oil sands slurry, comprising:
a first filter component comprising:
a first set of filter rings; and
a first support structure supporting the first set of filter rings;
a second filter component comprising:
a second set of filter rings arranged in alternating relation with respect to the first set of filter rings; and
a second support structure supporting the second set of filter rings;
wherein the first and second sets of filter rings form a stack having a passage defined within the stack and having an outlet, and wherein a filtration gap is defined between each adjacent pair of filter rings to filter the solid particles while allowing fluid to pass therethrough into the passage and then expelled via the outlet; and
a bearing system configured to provide spacing between the first and second sets of filter rings; and
a drive system configured to provide rotation of the first and second sets of filter rings with respect to each other.

2. The oil sands slurry filter cartridge of claim 1, wherein the first support structure is provided on an inner side of the first set of filter rings, and the second support structure is provided on an outer side of the second set of filter rings.

3. The oil sands slurry filter cartridge of claim 1, wherein the first support structure comprises a plurality of spaced-apart vertical support columns and first annular supports at opposed ends of the vertical support columns, each of the vertical support columns being connected to the filter rings of the first set of filter rings.

4. The oil sands slurry filter cartridge of claim 1, wherein the second support structure comprises a plurality of spaced-apart spiral support members and second annular supports at opposed ends of the spiral support columns, each of the spiral support columns being connected to the filter rings of the second set of filter rings.

5. The oil sands slurry filter cartridge of claim 1, wherein the drive system comprises a motor coupled to a drive shaft, wherein the drive shaft is coupled to the first support structure for rotating the first support structure and the first set of filter rings.

6. The oil sands slurry filter cartridge of claim 1, wherein the drive system configured to provide rotation of the first set of filter rings while the second set of filter rings are configured to remain stationary.

7. The oil sands slurry filter cartridge of claim 1, wherein the first and second sets of filter rings are sized and configured to receive solids-containing diluted bitumen as the oil sands slurry.

8. The oil sands slurry filter cartridge of claim 1, wherein the filtration gap is between 100 and 400 microns.

9. The oil sands slurry filter cartridge of claim 1, wherein the filter rings of the first and second sets of filter rings each have a wedge-shaped profile tapering inward toward the passage.

10. The oil sands slurry filter cartridge of claim 1, wherein the first and second filter components are configured such that the stack and the passage are oriented vertically with the outlet at a bottom end, when installed in a filtration vessel.

11. An oil sands slurry filter cartridge for filtering solid particles from an oil sands slurry, comprising:
a first filter component comprising:
a first set of filter rings; and
a first support structure supporting the first set of filter rings;
second filter component comprising:
a second set of filter rings arranged in alternating relation with respect to the first set of filter rings; and
a second support structure supporting the second set of filter rings;
wherein the first and second sets of filter rings form a stack having a passage defined within the stack and having an outlet, and wherein a filtration gap is defined between each adjacent pair of filter rings to filter the solid particles while allowing fluid to pass therethrough into the passage and then expelled via the outlet; and
wherein the filter rings of the first and second sets of filter rings have respective wedged-shaped profiles tapering inward toward the passage.

12. The oil sands slurry filter cartridge of claim 11, wherein the first support structure is provided on an inner side of the first set of filter rings, and the second support structure is provided on an outer side of the second set of filter rings.

13. The oil sands slurry filter cartridge of claim 12, wherein the wedged-shaped profile of each filter ring of the first set of filter rings comprises:
a neck extending outwardly from the first support structure; and
a wedge-shaped head extending and tapering outwardly from the neck and having an end surface that is spaced apart from the second support structure.

14. The oil sands slurry filter cartridge of claim 13, wherein the wedged-shaped profile of each filter ring of the second set of filter rings comprises:
a base extending inwardly from the second support structure; and
a wedge-shaped head extending and tapering inwardly from the base and having an end tip that is spaced apart from the first support structure.

15. The oil sands slurry filter cartridge of claim 14, wherein the end surface is located along a same plane as an inner end of the base.

16. The oil sands slurry filter cartridge of claim 14, wherein the end surface has a width that is the same as that of the base.

17. The oil sands slurry filter cartridge of claim 11, wherein the wedge-shaped profile is the same for each filter ring.

18. The oil sands slurry filter cartridge of claim 11, wherein the first and second sets of filter rings are configured to be rotatable with respect to each other.

19. The oil sands slurry filter cartridge of claim 11, wherein the first and second sets of filter rings are sized and configured to receive solids-containing diluted bitumen as the oil sands slurry.

20. The oil sands slurry filter cartridge of claim 1, wherein the first and second filter components are configured such that the stack and the passage are oriented vertically with the outlet at a bottom end, when installed in a filtration vessel.

21. The oil sands slurry filter cartridge of claim 1, wherein the first and second sets of filter rings are configured such that the passage defines a tortuous path.

22. A method for filtering an oil sands slurry comprising passing a flow of the oil sands slurry to a filtration unit comprising at least one filter cartridge to remove the solid particles therefrom and produce a solids-depleted fluid, and withdrawing the solids-depleted fluid from the filtration unit, wherein the filter cartridges comprises:
a first filter component comprising:
a first set of filter rings; and
a first support structure supporting the first set of filter rings;
a second filter component comprising:
a second set of filter rings arranged in alternating relation with respect to the first set of filter rings; and
a second support structure supporting the second set of filter rings;
wherein the first and second sets of filter rings form a stack having a passage defined within the stack and having an outlet, and wherein a filtration gap is defined between each adjacent pair of filter rings to filter the solid particles while allowing fluid to pass therethrough into the passage and then expelled via the outlet; and
wherein the filter rings of the first and second sets of filter rings have respective wedged-shaped profiles tapering inward toward the passage; or wherein the filter cartridge comprises a bearing system configured to provide spacing between the first and second sets of filter rings and a drive system configured to provide rotation of the first and second sets of filter rings with respect to each other.
